(19) United States
(12) Patent Application Publication
(10) Pub. No.: US 2018/0026311 A1
(43) Pub. Date: Jan. 25, 2018

(54) METHOD FOR OPERATING BATTERY CELLS OF A BATTERY, BATTERY AND MOTOR VEHICLE

(71) Applicant: AUDI AG, Ingolstadt (DE)

(72) Inventors: Michael HINTERBERGER, Großmehring (DE); Berthold HELLENTHAL, Schwanstetten (DE)

(73) Assignee: AUDI AG, Ingolstadt (DE)

(21) Appl. No.: 15/548,914

(22) PCT Filed: Feb. 11, 2016
(86) PCT No.: PCT/EP2016/052940

§ 371 Date: Aug. 4, 2017

(30) Foreign Application Priority Data
Feb. 18, 2015 (DE) 10 2015 002 148.6

(51) Int. Cl. H01M 10/42; H01M 10/48; H01M 2/10

(52) U.S. Cl. CPC H01M 10/425; H01M 2/1077; H01M 10/486; H01M 10/482; H01M 2220/20; H01M 2010/4271

(57) ABSTRACT

A method for operating at least two battery cells, which are electrically connected in parallel, of a battery for a motor vehicle. Each of the battery cells is provided with a galvanic element with two electrodes and a battery cell housing for accepting the galvanic element with two connections, and each of the electrodes is electrically coupled to a respective connection of the battery cell. A value of a state variable of each of the battery cells is measured, the values are compared to one another, and when there is a deviation of the values from each other which is outside of a predetermined tolerance range, an electric resistance is adjusted so that the deviation is within the predetermined tolerance range.

The invention relates to a method for operating at least two battery cells for a motor vehicle connected electrically in parallel, wherein each of the battery cells is provided with a galvanic element with two electrodes and a battery cell housing for receiving the galvanic element with two connections, and each electrode is electrically coupled to a connection of the battery cell. The invention relates also to a battery as well as to a motor vehicle with a battery.

It is already known from prior art that individual battery cells can be connected to batteries or to battery systems, for example via current rails or power cables. These batteries are nowadays used in particular as traction batteries in a motor vehicle, for example in electric or hybrid vehicles where they are used for driving the motor vehicle. In this case, the battery cells can be connected in series or in parallel. Due to the fact that with a parallel connection of battery cells, different resistance paths are created along the current rails or power cables, the battery cells also display different internal resistance levels and additionally, different transition resistance levels are created between the current rail and the respective connection points, which results in different current loads in the respective battery cells connected with a parallel connection.

Since the same electric voltage is applied to all battery cells in a parallel connection, a different current is produced for the battery cells as a result of the different internal resistances of the batteries. This includes battery cells whose overall resistance path is smaller and which are exposed to a higher load than battery cells with a larger overall resistance path. As a result of this unequal load, or due to these inhomogeneous requirements on the battery cells connected in parallel, limits are imposed in this manner on the lifespan and on the productivity (performance) of individual battery cells and thus also on the entire battery.

The object of the present invention is to provide a solution by means of which battery cells can be operated particularly gently and their lifespan can thus be extended in this manner.

This object is achieved according to the invention with a method, a battery and a motor vehicle having the features according to the independent claims. Independent embodiments of the invention are the subject matter of dependent claims, the description and the figures.

The method according to the invention serves to operate at least two battery cells for a motor vehicle connected electrically in parallel. In this case, each of the battery cells is provided with a galvanic element with two electrodes and a battery cell housing for receiving the galvanic element with two connections. In addition, each of the electrodes is electrically coupled to the respective connection. Moreover, one value of a state variable is measured for each of the battery cells. These values of the state variable are compared to each other. If there is a deviation of these values from one another which is beyond a predetermined tolerance range, an electric resistance between at least one electrode and one of the connections of at least one battery cell, and consequently a current load of at least one of the battery cells, is set in such a way that the deviation will be within the predetermine tolerance range.

The galvanic element of each of the battery cells is in particular designed as a secondary cell, which can be discharged for supplying an electric component, and then recharged again after discharging. The galvanic element is arranged in the battery cell housing, wherein a first of the electrodes is galvanically coupled to a first connection and a second of the electrodes of the galvanic element is electrically coupled to the second one of these connections. In this manner, the electric energy provided by the galvanic element can be tapped at the connections, or electric energy can be supplied to the galvanic element via the connections for charging.

The battery cells are electrically connected in parallel. In this case, the respective first connections of the battery cells, are connected to each other for example via current rails or via a current cable, and the second connections of the battery cells are electrically connected to each other. It can be also provided that at least two battery cells are electrically connected in parallel to a battery module and the battery module is for example electrically connected in series to at least one further battery module of the same type to the battery.

The value of the state variable for the battery cells, in particular for each of the battery cells, is detected and the values of the state variables of the battery cells are compared with one another. For this purpose, the values can be for example transmitted to a higher-level control device. Each of the batteries can be provided with a communication device for the transmission, for example in the form of a radio antenna through which the values can be transmitted wirelessly.

An effort is made to ensure that the values of the state variables are approximately equal, which is to say that the deviations between the values is approximately zero. When the values are deviating from one another beyond the predetermined tolerance range, this may indicate an unbalanced load in the battery cells connected in parallel or a defect of a battery cell.

Moreover, the resistance between at least one of the electrodes and the connection coupled to this electrode is dynamically adapted to at least one battery cell. In other words, this means that an internal resistance of the at least one battery cell is changed dynamically. With the dynamic matching of the internal resistance, a current load of the at least one battery cell is set so as to compensate for the deviation of the values of the state variable of the individual battery cells from each other.

When for example the value of the state variable deviates from the state variable of the other battery cells, the electric resistance of the battery cell that is deviating can be dynamically adjusted. With the adjustment, the value of the status variable of the deviating cell can be set again so that it has approximately the same value of the state variable as the other battery cell. It can also be provided that the resistance levels of all battery cells are dynamically matched in order to mutually align the values of the state values of all batteries to each other.

With this dynamic adjustment of the resistances, the lifespan individual battery cells and the productivity of the battery cell can be increased in an advantageous manner.

It is particularly preferred when for a state variable is used electric current, in particular current that is preferably measured between at least one electrode and the respective connection of the respective battery cell. In other words, this means that the electric currents of the battery cells are mutually compared to each other. Since as was already mentioned, an unequal current load leads in a parallel connection of the individual battery cells to restrictions relating to the lifespan and to the performance, these unequal current loads can be compensated for with the dynamic matching of the inner resistance of each of the battery cells.

In order to measure the current, each of the batteries can be provided with a current sensor which detects the current, in particular between the electrode and the connection of the respective battery cell. These current values can be for example transmitted to a superordinate control device which compares the current values of the individual battery cells to each other. When the deviation between the individual current values is outside of the predetermined tolerance range, the control device can change the resistance between the at least one electrode and the connection of at least one of the battery cells and thus the current load of the at least one battery cell for as long until all the current values are equal.

Since the same electric voltage is applied to all battery cells, the dynamic matching of the resistance levels between the electrodes and the respective connections compensates for different current loads and thus ensures a symmetrical current load of the individual battery cells.

It can be also provided that a temperature inside the battery cell housing of the respective battery cell is measured as the state variable. For this purpose, the batteries can be for example provided with a temperature sensor so that this value of the temperature is communicated for example to the superordinate control device. When for example a battery cell is overheated, for instance due to local temperature high points or so-called “hot spots” in the battery cell, the temperature of this battery cell deviates from the temperatures in the other battery cells. As soon as the deviation is outside of the tolerance region, the internal resistance of this battery cell is in particular increased so that the current load of this battery cell and thus also the temperature of this battery cell is lowered.

It can also be provided that the control device detects a defect of the battery cell based on the increased temperature. In this case, the resistance of this battery cell is maximally increased so that the current flow will be uninterrupted.

According to a further development of the invention, as a state variable is used a charge state of the respective battery cell. For this purpose, each of the battery cells can be provided for example with a voltage sensor which detects the voltage of the battery cell and thus also the charged state of the respective battery cell. Therefore, by detecting the charging status during the charging of the battery or so-called SoC (State of Charge) and with the dynamic matching of the of the internal resistance state of the individual battery cells, the supplying of current can be individually matched to the state of charge of the respective battery cells. This makes it possible to prevent that individual battery cells will be overcharged, so that for example the internal resistance levels of the respective battery cells are increased with the higher charging status. The performance of the entire battery is thus increased in this manner. During the discharging of the battery, deep discharging of individual battery cells can be prevented by detecting the charging status and with the dynamic matching of the resistance levels.

For example, in particular a semiconductor switch is operated in order to set the resistance of an electronic switching element. In this case, at least one electrode of the battery cell is connected via the electronic switching element to the respective connection. In particular, both electrodes of each battery cell are connected to the respective connections via the respective electronic switching element. The current flow can be controlled in the electronic switching element by means of a control signal, for example with the control voltage on the electronic switching element. The electronic switching element can be controlled for example with the superordinate control device or with a control device of the actual battery cell.

The electronic switching element, which can be designed for example as a power MOSFET (metal oxide semiconductor field transistor) or as an IGBT (insulated gate bipolar transistor), can be operated in different ranges depending on the control voltage. When the electronic switching element is operated in a blocking range, which is to say when the control voltage is below a predetermined threshold value, the electronic switching element blocks or prevents a current flow between the electrode and the respective connection. This means that the electronic resistance between the electrode and the connection is at its maximum. When both electrodes are connected via respective electronic switching element of a battery cell to the respective connection, the battery cell can be completely decoupled from the other battery cells of the parallel connection by completely blocking the current between both electrodes and the connection.

When the electronic switching element is operated in a linear region or in a triode region, the current flow can be increased linearly by increasing the control voltage of the current flow.

When the electronic switching element is operated in a saturation region, a constant, maximum current can flow between the connection and the electrode from a certain control voltage. This means that the electric resistance between the electrode and the connection is minimal.

The dynamic resistance matching can be carried out by operating the electronic switching element in a particularly simple and reliable manner.

According to another development of the invention, in order to adjust the resistance, the resistance of the electronic switching element is operated in a linear region in which the electronic switching element displays a conduct without an ohmic resistance. In the linear range, a current can be varied via the electronic switch, and a current can thus be varied between the electrode and the connection proportionally to the applied control voltage. Therefore, the resistance between the electrode and the connection can be adjusted by providing the appropriate control voltage. In this case, the control voltage can be preset individually for each battery cell, in particular as an analog signal, and the resistance can be thus individually preset for each battery cell. For this purpose, the corresponding control of the switching element of a battery cell can be carried out for example with an actual control device of the of the battery or with a superordinate control device.

According to another embodiment of the invention, the electronic switching element is clocked in order to adjust the resistance. In other words, this means that the switching element is operated alternately in the blocking range and in the saturation range. For this purpose, a digital signal can be preset, particularly preferred is a pulse-width modulated signal, for controlling the electronic switching element. The corresponding resistance or the current is in this case adjusted over the pulse duration of the clocked signal. When the resistance of several battery cells is dynamically adjusted, an individual signal can be preset for each battery cell. Digital signals are particularly advantageous as they are particularly safe and almost without interference, for example since they can be transmitted by a superordinate control device.

The invention also provides a battery for a motor vehicle with at least two battery cells connected in parallel, wherein each of the battery cells is electrically coupled to a galvanic element with two electrodes and a battery electrode housing for receiving the galvanic element with two connections, and each of the electrodes is electrically coupled to a respective connection of the battery cell. In addition, each of the battery cells is provided with at least one sensor device for detecting a value of a state variable. In addition, the battery comprises a control device, which is configured to compare the value of the state variables to each other and to a deviation of a value that is outside of the prescribed tolerance region in order to set an electric resistance between at least one electrode and at least one of the connected of at least one of the battery cells, and consequently to set a current load of at least one of the battery cells so that the deviation remains within the prescribed tolerance range.

A motor vehicle according to the invention comprises at least one battery according to the invention. The motor vehicle can be configured for example as a personal automobile, in particular as an electric vehicle or as a hybrid motor vehicle. However, the motor vehicle can be also an electrically operated motorcycle or bicycle.

It is moreover also possible to provide the battery in a stationary energy storage system. In this case, it can be for example provided that the battery that was provided in a motor vehicle is reused as a so-called second life battery in the stationary energy storage system.

With respect to the preferred embodiments of the battery cells according to the invention presented here and their advantages, they apply correspondingly to the battery according to the invention as well as the motor vehicle according to the invention.

The invention will now be explained in more detail in the following on its preferred embodiments with reference to the attached figures.

The figures show the following:

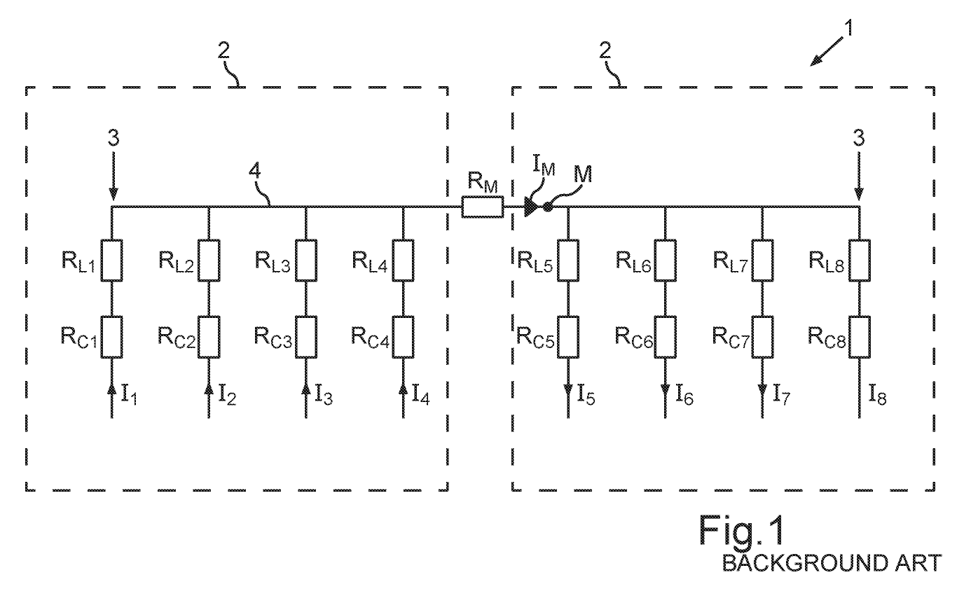

FIG. 1 an equivalent circuit diagram of battery cells which are mutually connected to one another via a current rail according to prior art;

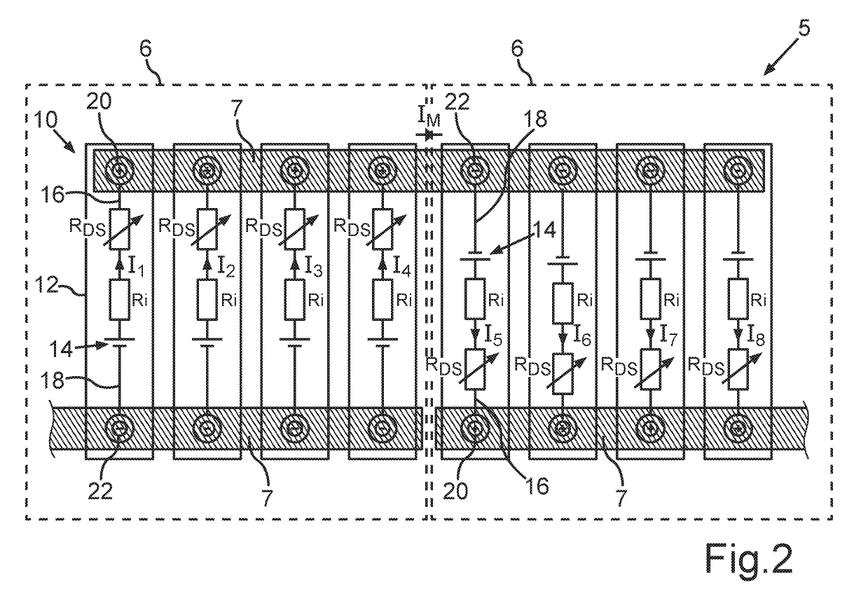

FIG. 2 a schematic representation of a section of the battery; and

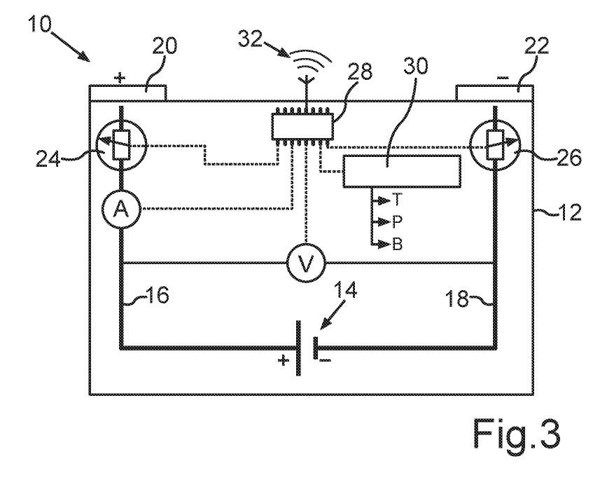

FIG. 3 a schematic representation of a section of a battery, wherein the resistance can be changed by means of electronic switching elements;

The same or functionally equivalent elements in the figures are provided with the same reference symbols.

The embodiments described below are preferred embodiments of the invention. The components described in the embodiments, however, represent features of the invention that should be considered independently of each other, which are further developed independently of each other and thus should be considered also individually or in other combinations of the invention than those shown. In addition, the described embodiments can be also complemented by other already described features of the invention.

FIG. 1 shows an equivalent circuit diagram of a section of a battery 1 with eight battery cells according to prior art. The battery 1 comprises a series circuit of battery of a battery module 2, of which the equivalent circuit diagram here shows two battery modules 2. Each of the battery modules 2 is provided with a parallel circuit comprising several battery cells 3, of which the equivalent circuit diagram shows schematically four battery cells 3 per battery module 2. The battery cells 3 are connected in parallel via an electric connector 4, for example with a current rail or a current cable, within the battery module 2. In addition, the battery module 2 is connected in series via the connector 4.

In such a parallel connection of a plurality of battery cells 3, different wavelength are created resulting in different total resistance paths. In this case, the resistances R_{L1}, R_{L2}, R_{L3}, R_{L4}, R_{L5}, R_{L6}, R_{L7}, R_{L8} symbolize the respective wavelengths to be bridged over to a node point or a total current collection point M. The resistances R_{C1}, R_{C2}, R_{C3}, R_{C4}, R_{C5}, R_{C6}, R_{C7}, R_{C8} symbolize the transitional resistances between the respective connections of the battery cells 2 and the current rails or current cables. R_{M} symbolizes the current transition resistance path from the first battery module 2 illustrated on the left side, to the next battery module 2 illustrated on the right side. A total current IM flows via the node point M from the first battery module 2 into the second battery module 2.

The batteries are subjected to different loads with the different resistances R_{L1}, R_{L2}, R_{L3}, R_{L4}, R_{L5}, R_{L6}, R_{L7}, R_{L8}, R_{C1}, R_{C2}, R_{C3}, R_{C4}, R_{C5}, R_{C6}, R_{C7}, R_{C8}, which is to say that the currents I₁, I₂, I₃, I₄, I₅, I₆, I₇, I₈ of the battery cells 3 may deviate from each other. This unequal load on the battery cells 3 of the battery 1 according to prior art can result in a limited lifespan of the battery 1 and it can thus lead to a premature failure of the battery 1.

FIG. 2 shows a section of a battery 5 by means of which the disadvantages of the battery 1 according to prior art can be avoided. The battery 5 includes a series circuit comprising battery modules 6, of which two battery modules 6 are schematically shown here. Each of the battery modules 6 is provided with a parallel circuit comprising a plurality of battery cells 10 of which four battery cells 10 are schematically indicated here per battery module 6. Such a battery 5 can be arranged for example in a motor vehicle, not shown here, for driving the motor vehicle. However, such a battery 5 can be also provided in a stationary energy supply system, not shown here.

As shown for example in FIG. 3, each of the battery cells 10 comprises a battery cell housing 12. Inside the battery cell housing 12 is arranged a galvanic element 14 whose electrodes are electrically coupled via arresters 16, 18 to connections 10, 22 of the battery cell 10. In this case, a positive electrode is electrically connected via the arrester 16 to a first connector 20 or a positive pole of the battery cell 10, and a negative electrode is electrically connected via the arrester 18 to a second connection 22 or a negative pole of the battery cell 10.

To create a parallel circuit, the first connections 20 of the parallel cells 10 within the battery module 6 are electrically connected and the second connections 22 of the battery cells 10 are also electrically connected. The battery modules 6 are electrically connected in series, wherein the first connections 20 of the battery module 6 illustrated on the link-side are electrically connected with the second connections 22 of the battery module 6 illustrated on the right side. The electric connection between the battery modules 6 and the battery cells 10 can be established by means of current rails 7.

Each of the battery cells 10 is provided with an internal resistance R₁, which depending on its manufacturing and/or aging can vary between the battery cells 10. This means that each of the battery cells 10 can be provided with another inner resistance R₁. For this reason and due to different resistance paths connected with the battery 1 resulting from prior art as described, the currents I₁, I₂, I₃, I₄, I₅, I₆, I₇, I₈ of the battery paths can differ from each other. The battery cells 10 are there exposed to an asymmetrical load. In order to ensure an equal current load, an electric resistance R_{DS} can be adjusted between the electrodes of the galvanic element 14 of at least one battery cell 10 and the connections 20, 22 of the same battery cell 10 so that the entire internal resistance Rᵢ+R_{DS} of this battery cell 10 can be dynamically adjusted.

In order to detect the current I₁, I₂, I₃, I₄, I₅, I₆, I₇, I₈ of the respective battery cell 10, each of the battery cells 10 can be provided with a current sensor A (see FIG. 3). This detected current I₁, I₂, I₃, I₄, I₅, I₆, I₇, I₈ can be transmitted to a superordinate control device, not shown here. For this purpose, each of the battery cells 10 can be provided with a communication device 32, which is designed for example in the form of a radio antenna and which can transmit the data of the current sensor A via a WLAN or Bluetooth to the superordinate device.

The values of the currents I₁, I₂, I₃, I₄, I₅, I₆, I₇, I₈ are mutually compared to each other, for example by the control device. When a deviation of the values of the currents I₁, I₂, I₃, I₄, I₅, I₆, I₇, I₈ is due to an asymmetrical load which is outside of a predetermined tolerance range, the electric resistance R_{DS} between one of the electrodes of the galvanic element 14 and the respective connection 20, 22 of at least one battery cell 10 is dynamically changed. The electric resistance R_{DS} is in this case adjusted in such a way that the deviation of the current values I₁, I₂, I₃, I₄, I₅, I₆, I₇, I₈ is within the tolerance range.

In particular, one resistance R_{DS} of the battery cell 10 is exposed to a higher load, for example as a result of its smaller total resistance path. Therefore, the current load can be reduced for this battery cell 10. The resistance R_{DS}, which is due for example to a larger total resistance path of the battery cell 10 which has a lower load, can be reduced so that the current load of these battery cells 10 is increased.

In order to adjust the electric resistance R_{DS} between the connections 20, 22 and the electrodes of the galvanic element 14, each of the battery cells 10 can be provided with at least one electronic switching element 24, 26 as shown in FIG. 3. As illustrated in FIG. 3, the positive electrode is electrically coupled by means of a first electronic switching element 24 to the first connection 20 or to the positive pole of the battery cell 10, and the negative electrode is electrically connected by means of a second electronic switching element 26 to the second connection 22 or to the negative pole of the battery cell 10. The switching elements 24, 26 are in particular semiconductor elements which are designed for example as power transistors with variable transmission resistance.

A current flow can be predetermined between the electrodes and the connections 20, 22 by means of the switching elements 24, 26, for example by providing a corresponding control voltage. The switching elements 24, 26 can be operated for example in a blocking range in which with the maximum transmission resistance (R=∞), the electrically conducting connection between the arrestors 16, 18, and the electric connections 20, 22 and thus also between the galvanic element 14 and the connections 20, 22 is uninterrupted.

The switching elements 24, 26 can be operated in a linear operation, in which the current can be linearly increased or reduced by increasing or reducing the control voltages. In the linear range, the switching elements 24, 26 therefore behave as ohmic resistances.

When the electronic switching elements 24, 25 are operated in a saturation range, a constant, maximum current can flow between the connections 20, 22 and the galvanic element 14 from a certain control voltage with a minimum transmission resistance (R=0).

The switching elements 24, 26 can be controlled for example by an internal battery cell control device 28 and they can be operated in the corresponding range. So for example, with a deviation of the detected current value exceeding the tolerance range of the higher-order control device of the internal battery cell control device 28, the battery cell 10 or those battery cells 10 that are addressed, will be addressed for example via the communication device 32 that their resistance R_{DS} is to be dynamically changed. After that, at least one of the switching elements 24, 26 is controlled by the internal battery control device 28, which adjusts the current between electrode and the respective connection 20, 22. The switching elements 24, 26 can be operated in a clocked manner for example by providing an analog control signal in the linear range, or by providing a digital signal.

Moreover, as shown in FIG. 3, the battery cell 10 is provided with a sensor device 30, by means of which a temperature T, as well as a pressure P and an acceleration B of the battery cell 10, can be detected here. If for example the temperatures T of the individual battery cells 10 deviate from one another, which is to say with an asymmetrical temperature load, the temperatures T of the individual battery cells 10 can be adjusted with a variation of the current load, which is to say with the variation of the electric resistance R_{DS}. In this case, although the battery cells 10 have different current loads, the temperatures of the individual battery cells 10 are preset and matched to each other via the different current loads.

It may also occur that for example the temperature T of a battery cell 10 exceeds a predetermined threshold value for the temperature due to a defect of the battery cell 10. In this case, the switching elements 24, 26 are both operated in the blocking range, for example by the internal battery cell control device 28. As a result, this battery 10 cell is decoupled from the battery 5.

In addition, the battery cell 10 is here provided with a voltage sensor V for detecting a battery cell voltage and thus a charging state of the battery cell 10. The resistance R_{DS} can thus be adapted also to the charging states of the individual battery cells 10. Therefore, this makes it possible to ensure that all battery cells 10 are charged and/or discharged uniformly and in particular that they will not be overcharged and/or deep-discharged.

1-10. (canceled)

11. A method for operating at least two battery cells, which are electrically connected in parallel, of a battery for a motor vehicle, wherein each of the battery cells is provided with a galvanic element provided with two electrodes and a battery housing for accepting the galvanic element with two connections, and each of the electrodes is electrically coupled to a respective connection of the battery cell, comprising:
each respective value of a state variable of the battery cells is measured, the values of the state variables of the battery cells are compared to one another and when there is a deviation of the mutual values which is outside of a predetermined tolerance range, an electric resistance is adjusted between at least one electrode and one connection of at least one battery cell, so that the deviation is within the predetermined tolerance range.

12. The method according to claim 11, wherein the state variables are an electric current between an electrode and the respective connection of the respective battery cell.

13. The method according to claim 11, wherein the state variable is a temperature inside the battery cell housing of the respective battery cell.

14. The method according to claim 11, wherein the state variable is the charging state of the respective battery cell.

15. The method according to claim 11, wherein an electronic switching element is operated in order to adjust the resistance.

16. The method according to claim 15, wherein in order to adjust the resistance, the electronic switching element is operated in a linear region in which the electronic switching element displays the conduct of an ohmic resistance.

17. The method according to claim 16, wherein in order to adjust the resistance, the electronic switching element is operated in a clocked manner.

18. The method according to claim 17, wherein in order to adjust the resistance, a pulse-width-modulated signal is preset for the electronic switching element of the respective battery cell.

19. A battery for a motor vehicle, comprising:
two battery cells electrically connected in parallel, wherein each of the battery cells is provided with a galvanic element with two electrodes and a battery cell housing for receiving the galvanic element provided with two connections, and each of the electrodes is electrically coupled to the respective connection of the battery cell, wherein each of the battery cells is provided with at least one sensor device, and the battery is provided with a control device which is adapted to compare the values of the state variable of each of the battery cells to one another and if there is a deviation of the values which is outside of a predetermined tolerance range, to adjust an electric resistance between at least one electrode and at least one of the connections of at least one of the battery cells, so that the deviation is within the predetermined tolerance range.
